(19) United States
(12) Patent Application Publication
(10) Pub. No.: US 2008/0080732 A1
(43) Pub. Date: Apr. 3, 2008

(54) ELECTRONIC DEVICE CARRYING SYSTEM WITH RETRACTABLE TRANSDUCER ASSEMBLY

(76) Inventor: Brian Sneed, Fort Worth, TX (US)

Correspondence Address: CARSTENS & CAHOON, LLP, P O BOX 802334, DALLAS, TX, 75380, US

(21) Appl. No.: 11/537,513

(22) Filed: Sep. 29, 2006

(51) Int. Cl. H04R 25/00

(52) U.S. Cl. 381/374; 381/370

(57) ABSTRACT

An electronic device carrying system having a retractable headphone assembly is disclosed. The carrying system is adapted to support an electronic device and to attach to a user or their garments. A first plug configured to communicate with the electronic device is connected to a second plug on the front side of the housing, said plugs being connected by a connector cable secured to the housing. A user controlled, spring operated spool secured to the housing is adapted to extend and retract a transducer assembly having at least one transducer and a headphone cable. One or more conducting brackets are mounted within an aperture formed into the spool, the spool being configured to rotate about said second plug. The conducting brackets, each having a plurality of contact surfaces, electrically couple the transducer assembly to the second plug in a secure manner.

### FIELD OF THE INVENTION

The present invention relates generally to an apparatus for carrying an electrical device and in particular to a carrying system having a retractable transducer assembly attached thereto. Still more particularly, the present invention provides for a carrying system for a portable electronic device having a user controlled retractable transducer assembly and an improved means for electrically coupling said transducer assembly to said electronic device.

### DESCRIPTION OF THE RELATED ART

Portable electronic devices such as mobile phones, digital music players, personal digital assistants, and the like, are often configured to be used by those with active lifestyles. In fact, many users enjoy using their portable electronic devices while exercising, thus subjecting said devices to stresses not ordinarily generated during stationary use. The prior art reveals many accessory items which provide for greater ease in carrying electronic devices. Some of these items provide the user with an improved means for carrying their portable electronic device such that the device may be secured to the body of the user or to a garment worn by the user, allowing the device to be carried hands-free. Many electronic devices permit the insertion of a plug connected to a transducer such as a headphone, allowing the user to listen to audio from the device in a hands-free manner. Similarly, telecommunication devices often allow for the insertion of a plug connected to both a microphone and a headphone. Lengthy cords connecting the transducers to the electronic device can become a nuisance to the user. When not in use, the user must store the cord on their person or in some other location. Furthermore, when the user is engaged in non-stationary activities such as exercise, excess cord can potentially snag on other adjacent items, possibly pulling the transducers from the user's ears or damaging the electronic device.

Several prior art carrying systems disclose housing structures containing a retractable transducer assembly utilizing a spool, said spool providing a means for conveniently storing the cord of the transducer assembly when not in use, and for retracting excess cord when so desired. Differing means for electrically coupling the retractable transducer assembly to the electronic device are revealed in said prior art carrying systems.

Such a carrying system is revealed in the U.S. Pat. No. 6,567,651 by Whitley. A belt clip device having a retractable transducer lead is disclosed. The transducer leads are internally connected to conducting brushes configured to make contact with a printed circuit board. The printed circuit board is configured to remain stationary while the brushes, being attached to a rotatable spool, move relative to said board. A secondary cord containing a plug adapted for insertion into an electronic device is connected to the printed circuit board. Whitley '651 does not teach that the secondary cord is otherwise secured to the housing of the carrying system. One drawback of such a carrying system is that the unsecured portion of the secondary lead can potentially snag on adjacent items.

Another carrying system having a retractable transducer assembly is revealed in the U.S. Pat. No. 6,633,770 to Gitzinger et al. Gitzinger '770 discloses a telecommunication device holster having a retractable transducer assembly and teaches that the wire ends of the transducer cord make electrical contact with a coil spring, said coil spring also providing a biasing force for retracting said transducer assembly. Specifically, Gitzinger '770 teaches that the coil spring and the wire ends of the transducer cord may be connected by any manner of establishing continuous contact, including slip rings, brushes, and the like. The coil springs are also connected to electrical contacts adapted for further connection to the telecommunication device. A drawback of such a carrying system is that the means for connecting the transducer assembly to multiple spring coils which are further connected to multiple electrical contacts is that it is a relatively complex mechanism, thus making the system expensive to manufacture, and potentially more susceptible to stresses encountered during non-stationary use.

A need exists for an electronic device carrying system which has a retractable transducer assembly and a simple, yet rugged means for electrically coupling the transducer assembly to the electronic device.

### SUMMARY OF THE INVENTION

According to the present invention, there is provided an apparatus for carrying a portable electronic device such that the apparatus may be secured to a user or a garment worn by the user, and includes a retractable transducer assembly electrically coupled to the electronic device in a secure manner.

In a preferred form of the present invention, the carrying system includes a housing adapted to removably support an electronic device. The housing structure contains a means for being secured to a user or a user's garments, thus allowing for hands-free operation of the electronic device. The electronic device, being secured to the rear side of the housing, is connected to a connector cable which includes a first plug adapted for insertion into the electronic device, and further includes a second plug which extends from the front side of the housing. The first plug and the second plug are connected by the connector cable which is secured to the rear side of the housing. The length of connector cable that is not secured to the housing in order that the first plug may be inserted into the electronic device should be minimized. The portion of the connector cable not secured to the housing should be minimized in order to reduce the likelihood of said connector cable snagging on any adjacent items. The second plug has a generally cylindrical connecting portion similar to that found on a common audio jack plug. The connecting portion has a plurality of conducting regions that are electrically insulated from one another.

The carrying system further includes a transducer assembly, including at least one transducer and a headphone cable connected thereto. The headphone cable is wrapped around a retractable spool, permitting extension and retraction of the transducer. The spool is secured to the housing by a spool covering having an opening through which the headphone cable passes during extension and retraction. An actuator mechanism will allow the user to control the operation of the retractable spool. The headphone cable contains at least one conductor, each conductor having a first end connected to a transducer and a second end electrically coupled to one of a plurality of conducting brackets. The conducting brackets are mounted to the walls of a central aperture formed within the center of the spool and are configured to mount on the second plug such that the spool rotates about said second plug. The conducting brackets also provide a means for electrically coupling the second plug to the transducer assembly. Each conducting bracket makes contact with one conducting region of the second plug at a plurality of points surrounding the conducting region, thus electrically coupling the transducer assembly to the second plug in a secure manner. An advantage of electrically coupling the transducer assembly to the second plug in this manner is that the coupling is less susceptible to the stresses the carrying system may be subjected to by the user.

### BRIEF DESCRIPTION OF THE DRAWINGS

A more complete understanding of the carrying system of the present invention may be had by reference to the following detailed description when taken in conjunction with the accompanying drawings, wherein:

FIG. 1 is an exploded perspective view of the carrying system according to a preferred embodiment of the invention;

FIG. 2 shows a rear exploded perspective view of the carrying system shown in FIG. 1.

FIG. 3 shows a front perspective view of the inner portion and rear outer portion of the spool of the carrying system shown in FIG. 1;

FIG. 4 shows a rear perspective view of the spool shown in FIG. 1;

FIG. 5 shows a perspective view of a conducting bracket according to a preferred embodiment of the invention;

FIG. 6 shows a perspective view of a preferred manner of coupling the second plug to the conducting brackets of the present invention; and

FIG. 7 shows a rear perspective view of the housing shown in FIG. 1.

Preferred embodiments of the carrying system according to the present invention will now be described in detail with reference to the accompanying drawings.

### DETAILED DESCRIPTION OF THE PREFERRED EMBODIMENTS

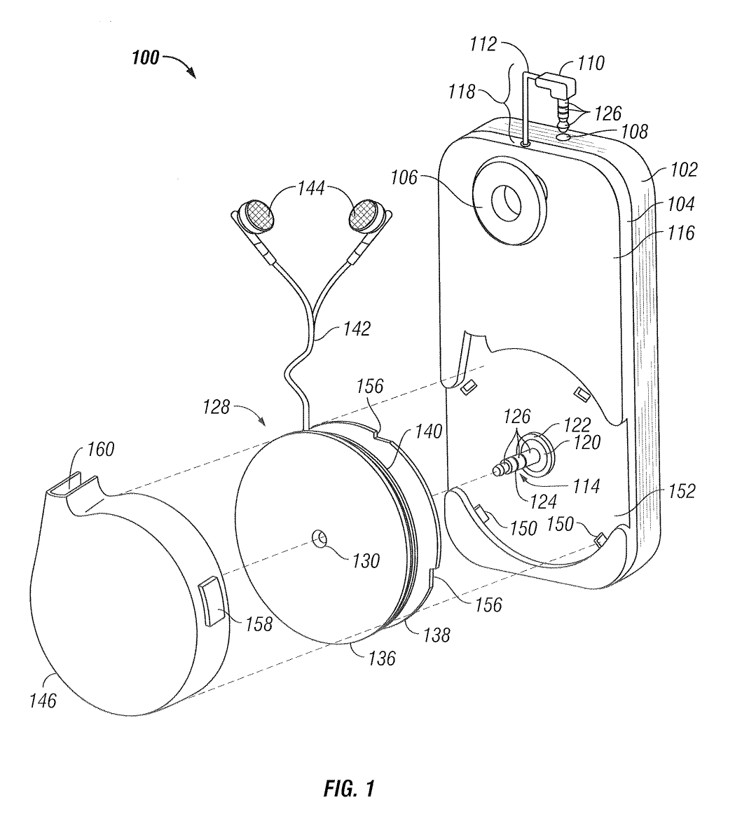

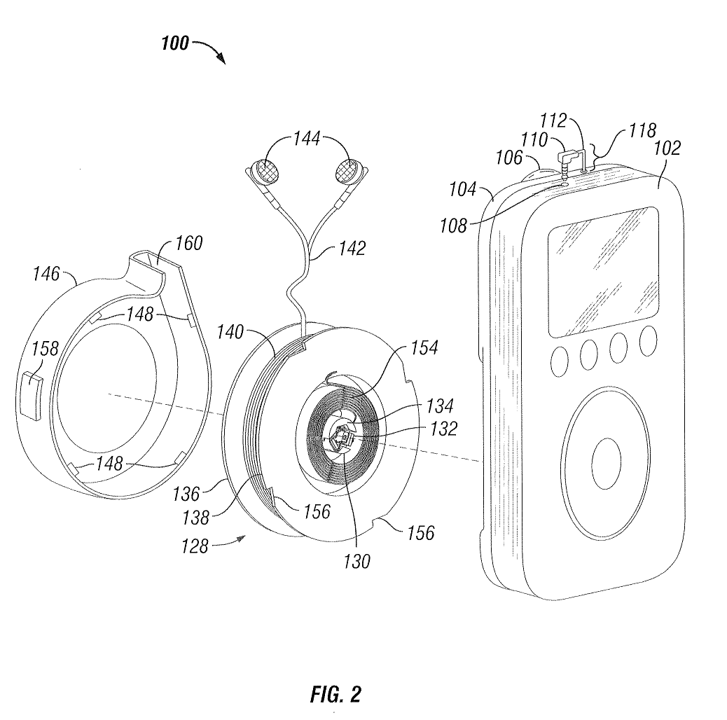

Referring to FIG. 1 and FIG. 2, a front and rear exploded perspective view of the carrying system 100 according to a preferred embodiment of the invention. The carrying system 100 is comprised of a retractable headphone assembly capable of supporting a portable electronic device 102. The portable electronic device 102 is removably supported by a housing 104. The housing 104 includes a means for securing (not shown) said device 102 to its rear side (not shown). The housing 104 further includes a means for attaching said housing 104 to a user or a garment worn by a user. Although the presently preferred embodiment of the invention includes a clip adapter 106 which may be attached to a clip (not shown) worn on the belt of a user, any means for attaching the carrying system 100 to a user or to garments worn by the user is contemplated. Alternate embodiments of the invention may contain an attaching means such as an armband, a neck strap, and the like. Furthermore, said means for attaching the carrying system 100 to a user or to garments worn by the user, may be secured to any surface of the housing 104. The material used to construct the housing 104 may include any material having properties suitable for forming in the manner disclosed herein. As those skilled in the art will appreciate, any conducting materials chosen to construct the housing 104 should be electrically insulated from other components configured to conduct electrical signals.

The electronic device 102, having an audio output socket 108 adapted to receive and communicate with a corresponding plug, is connected to a connector cable 112 having a first end comprising a first plug 110 that extends from the top side of the housing 104. The first plug 110 is connected to the connector cable 112, said connector cable 112 being connected to a second plug 114 which comprises a second end of the connector cable 112 and extends from the front side 116 of the housing 104. The connector cable 112 is secured to the housing 104 except for a small unsecured portion 118 which is necessary to allow the first plug 110 to connect to the electronic device 102. The length of the unsecured portion 118 of connector cable 112 should be minimized in order to reduce the likelihood of it snagging an adjacent object and thereby causing harm to the user or the carrying system 100. The placement of audio output sockets 108 varies among portable electronic devices 102 and therefore it should be noted that alternate embodiments of the invention will be configured to connect to said output sockets 108 at a plurality of points around the housing 104, while minimizing the length of unsecured connector cable 118.

The second plug 114 is attached to the front side of an adapter 120 configured to secure the electronic device 102 to the housing 104, said adapter 120 being mounted within an aperture 122 formed into said housing 104, said adapter 120 further configured to allow for communication between said second plug 114 and said connector cable 112. A connecting portion 124 of the second plug 114 extends from the front side 116 of the housing 104. Both the first plug 110 and the second plug 114 of the presently preferred embodiment have three exposed conducting regions 126 along the respective connecting portion 124 of said plugs 110, 114. As those skilled in the art will appreciate, the connecting portion 124 of the first plug 110 and the second plug 114 are commonly referred to as Tip Ring Sleeve (TRS) connectors because the connecting portion 124 of such plugs 110, 114 are divided into three conducting regions 126 found at the tip, the ring, and the sleeve of the connecting portion 124 respectively. Each of said conducting regions 126 is electrically insulated from the other adjacent conducting regions 126. A conductor (not shown) connecting each conducting region 126 of the second plug 114 with a corresponding conducting region 126 of the second plug 114, is bundled within the connector cable 112 and electrically insulated from other conductors.

The carrying system 100 contains a retractable spool 128 which includes a central aperture 130 having leads comprising conducting brackets 132 which are adapted to receive the second plug 114, upon which it rotates. Referring now specifically to FIG. 2, the conducting brackets 132 are mounted on the walls 134 of the central aperture 130 and are configured to receive the second plug 114, allowing said second plug 114 to rotate within said central aperture 130. Referring now once again to both FIG. 1 and FIG. 2, the spool 128 is configured to include an inner portion (not shown) having a reduced diameter relative to a front outer portion 136 and a rear outer portion 138. A transducer assembly 140 is wrapped around the inner portion of the spool 128. The transducer assembly 140 is comprised of a headphone cable 142 connected to one or more transducers 144. The transducers 144 which are included in the presently preferred embodiment are ear bud type headphones but it should be noted that other types and numbers of transducers 144 are also contemplated. The term “headphone cable” as used herein includes all manner of cables used to connect portable electronic devices to both headphones, microphones, and other transducers. Alternate embodiments of the invention may contain transducer assemblies 140 having different types of transducers 144 in combination, for example, a microphone/headphone combination. Likewise, alternate embodiments of the invention may include plugs 112, 114 and cables 112, 142 having a number of conductors bundled within that are greater or lesser than that of the preferred embodiment.

A spool covering 146 is adapted to secure the spool 128 to the housing 104, said spool covering 146 having tabs 148 (See FIG. 2) for attaching to said housing 104. The housing 104 contains a plurality of slots 150 adapted to receive and engage said tabs 148. It should be noted that any manner of attaching said spool covering 146 to said housing 104 is contemplated. A circular indentation 152 sized to conform to the shape of the spool 128 and spool covering 146 is formed on the front side 116 of the housing 104, providing said carrying system 100 with further means for securing said spool 128 to said housing 104.

The spool 128 is spring operated in order to assist the user in extending and retracting the transducer assembly 140. A spring 154 attached to the rear outer portion 138 and the front outer portion 136 provides a retracting force for rotating said spool 128 such that the transducer assembly 140 may be retracted. The presently preferred embodiment of the spool 128 is configured such that the rear outer portion 138 is a rotatable portion and the front outer portion 136 is a fixed portion firmly held in place by the spool covering 146, wherein the rear outer portion 138 holds the headphone cable 142 and is adapted for rotating relative to the front outer portion 136. However, it should be noted that alternate embodiments of the invention may include the spring 154 being attached to one of the rear 138 or front 136 outer portions of the spool 128, and also to the housing 104, wherein the rear outer portion 138 and the front outer portion 136 may be configured to rotate relative to one another or may be fixed with respect to their ability to move relative to one another. The rear outer portion 138 of the spool 128 contains an edge 156 that is configured for engagement by an actuator mechanism 158 found on the spool covering 146, said actuator mechanism 158 allowing the user to control the extension and retraction of the transducer assembly 140. Other means for controlling the extension and retraction of the transducer assembly 140 may be contained in alternate embodiments of the carrying system 100.

An opening 160 is formed on the spool covering 146 through which the headphone cable 142 passes during extension and retraction of the transducer assembly 132. The opening 160 is sized to prevent the passage of the transducers 144, allowing the user to access said transducers 144 when desired. Both the spool 128 and the spool covering 146 of the presently preferred embodiment are constructed of a plastic material. However, other materials suitable for forming the spool 128 and spool covering 146 in the manner described herein may be chosen for use in alternate embodiments of the invention. If the material chosen to construct the spool 128 or spool covering 146 is substantially conductive in nature, care should be taken to electrically insulate any portion of said spool 128 or said spool covering 146 which may contact any element of the carrying system 100 configured to conduct electrical signals.

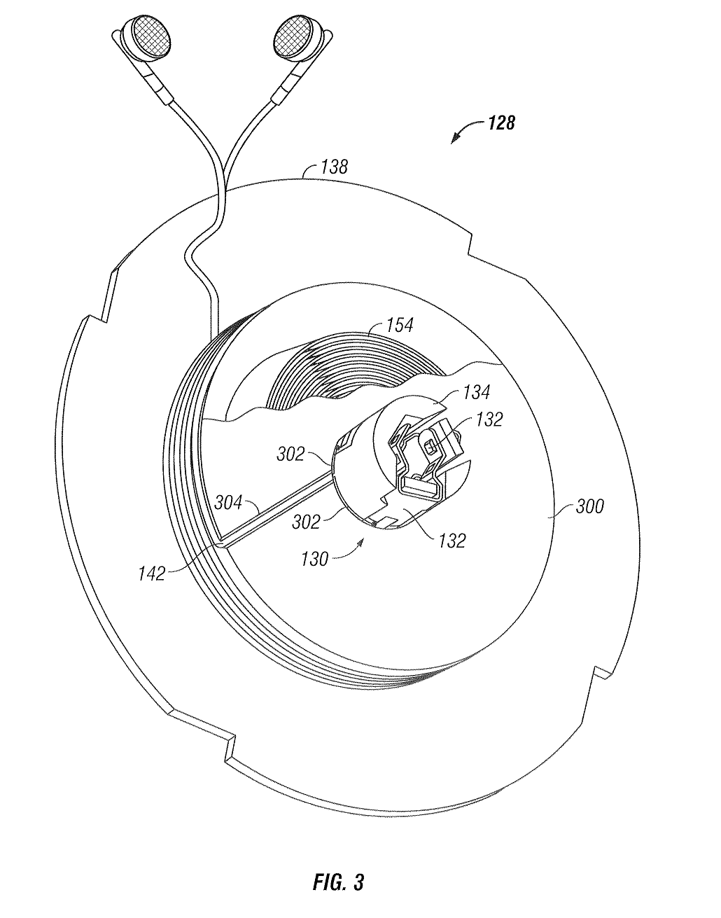

Referring now to FIG. 3, a front perspective view of the inner portion 300 and rear outer portion 138 of the spool 128 of the carrying system 100 shown in FIG. 1. The front outer portion 136 of the spool 128 appearing in FIG. 3 has intentionally been omitted in order to more clearly show all aspects of said spool 128 and components attached thereto. The walls 134 of the central aperture 130 are formed in such a manner as to allow the conducting brackets 132 to be mounted thereon. The conducting brackets 132 provide the means for electrically coupling the transducer conductors 302 bundled within the headphone cable 142, to the second plug 114 of the carrying system 100. Each transducer conductor 302 of the presently preferred embodiment is soldered to one conducting bracket 132. However, it should be noted that any means for electrically coupling said transducer conductors 302 to said conducting brackets 132 is contemplated and may be implemented in alternate embodiments. Each conducting bracket 132 is uniquely oriented with respect to the second plug 114. The walls 134 of the central aperture 130 are correspondingly configured to allow for secure mounting thereon. A channel 304 formed within the inner portion 300 of the spool 128 is adapted to allow the headphone cable 142 to pass through said inner portion 300 and connect to said conducting brackets 132. An adhesive means (not shown) for securing said headphone cable 142 within said channel 304 prevents tension applied to said headphone cable 142 from disconnecting the transducer conductors 302 from said conducting brackets 132. The spool 128 may be configured in alternate embodiments to include other means for securing said headphone cable 142 to said spool 128. Furthermore, the surfaces of alternate embodiments of the spool 128 may be formed in any manner which secures said headphone cable 142 to said spool 128. The spring 154 is visible in the cut-away view shown in FIG. 3.

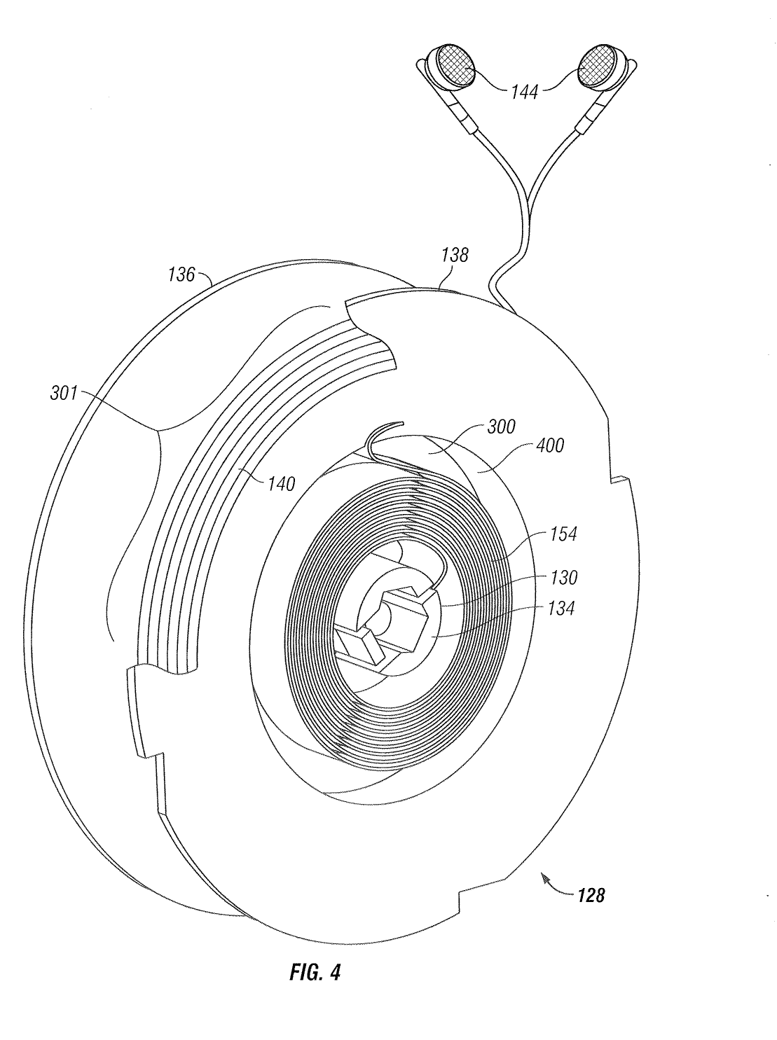

Referring now to FIG. 4, a rear perspective view of the spool 128 shown in FIG. 1. It should be noted that FIG. 4 depicts a cut-away view 301 through the rear outer portion 138 of the spool 128 in order to more clearly show the manner in which the transducer assembly 140 is wrapped around said spool 128. The inner portion 300 of the spool 128 provides a cavity 400 in which the spring 154 may be housed, said spring 154 providing the force necessary to rotate the rear outer portion 138 of the spool 128 and thereby retract the transducers 144. The walls 134 of the central aperture 130 extend from said rear side of the inner portion 300 of the spool 128 and are adapted for engaging the conducting brackets 204 in their varied orientations. It should be noted that the conducting brackets 132 have been intentionally omitted from FIG. 4 in order to clearly show the walls 134 of the central aperture 130.

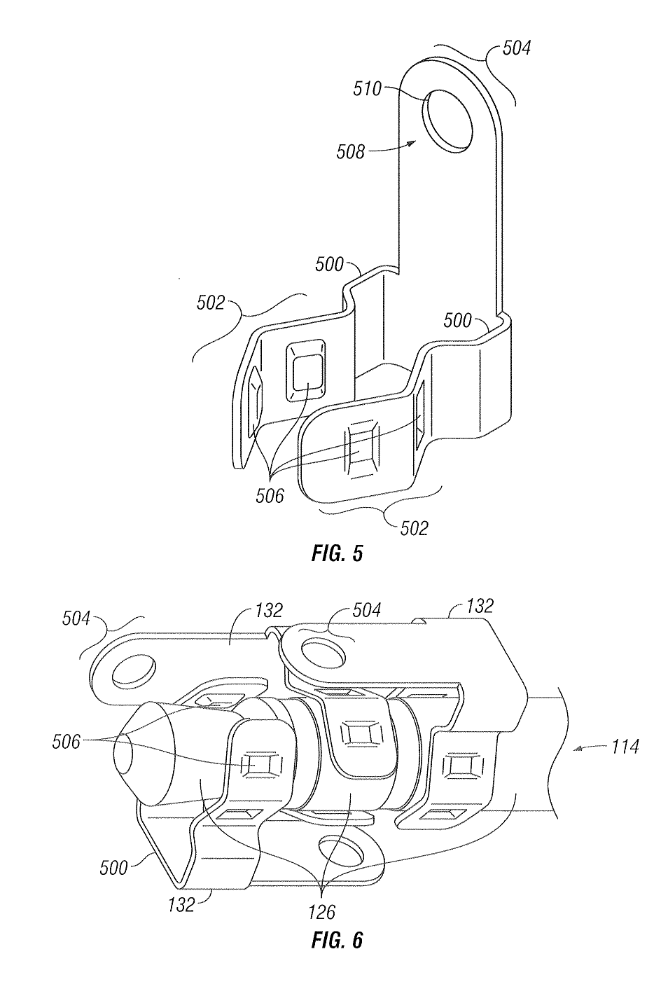

Referring now to FIG. 5 and FIG. 6, perspective views of a preferred embodiment of a conducting bracket 132 and a preferred manner of coupling the second plug 114 to said conducting brackets 132 of the present invention respectively. Each conducting bracket 132 electrically couples one transducer conductor 302 with one corresponding conducting region 126 of the second plug 114. The conducting brackets 132 each include a mounting portion 500 for attachment to a correspondingly configured portion of the central aperture wall 134. The conducting brackets 132 further include a first conducting portion 502 and a second conducting portion 504. The first conducting portion 502 contains a plurality of contact surfaces 506. The contact surfaces 506 of each conducting bracket 132 are configured to make contact with one conducting region 126 of the second plug 114 at points around said conducting region 126, each conducting bracket 132 engaging a different conducting region 126. When the rear outer portion 138 of the spool 128 rotates during extension and retraction of the transducer assembly 140, said contact surfaces 506 maintain a continuous electrical connection with their corresponding conducting region 126. Because the contact surfaces 506 surround the conducting regions 126 of the second plug 114, it is less likely that the connection will be disrupted should the carrying system 100 be dropped from a height or strained in some other manner. This provides a more secure manner of connecting the electronic device 102 to the transducer assembly 140 and is an advantage not seen in prior art systems.

The second conducting portion 504 of the conducting bracket 132 is adapted to provide a surface for connecting one of the transducer conductors 302 to said conducting bracket 132. The presently preferred embodiment of the carrying system 100 has a hole 508 formed into said conducting bracket 132, the edge 510 of said hole 508 providing a surface upon which the transducer conductors 302 may be soldered.

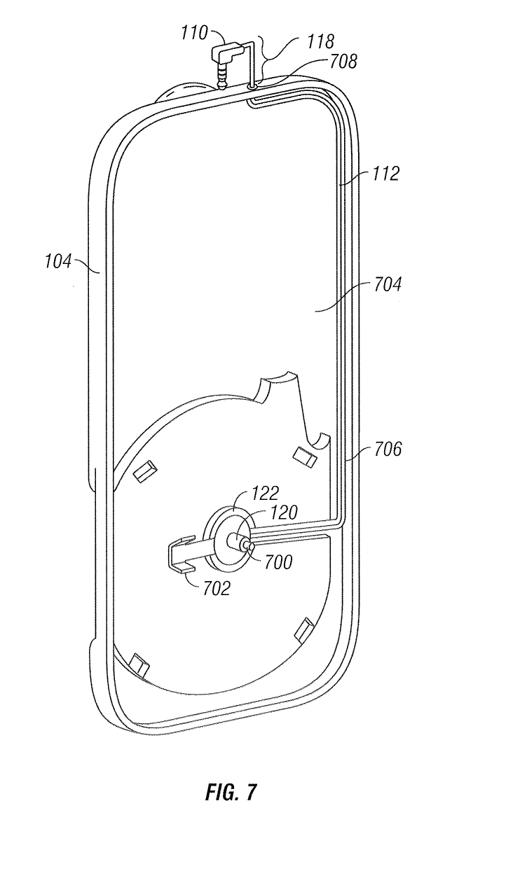

Referring now to FIG. 7, a rear perspective view of the housing 104 shown in FIG. 1. An adapter 120 for removably securing said electronic device 102 to said housing 104 protrudes from the aperture 122. Said adapter 120, having both a pin 700 and an arm 702, is configured to secure the electronic device 102 to the rear side 704 of the housing 104. Any means for removably securing said electronic device 102 to said housing 104 is contemplated and may be included in alternate embodiments of the invention. For example, the housing 104 of alternate embodiments may be configured to include any one of various well known latching means for securing at least one side of the portable electronic device to said housing 104. The connector cable 112, connected to both the first plug 110 and the second plug 114, is secured within a channel 706 formed into the rear side 704 of said housing 104. The unsecured portion 118 of the connector cable 112 extends through a hole 708 formed into the top side of said housing 104 and connects to the first plug 110. It should be noted that alternate embodiments of the invention may include other means for securing the connector cable 112 to the housing 104, said other means including adhesives, fasteners, and the like.

It should also be noted that the descriptions and embodiments disclosed herein are not exhaustive and are illustrative only. Many modifications and variations will be apparent to those of ordinary skill in the art. Accordingly, the protection sought herein is as set forth in the claims below.

I claim:

1. A retractable headphone assembly for use with an electronic device having an audio output, comprising:
(a) a housing adapted to engage the electronic device;
(b) a connector cable coupled to the housing having a first end and a second end, wherein the first end engages said audio output from the electronic device; and
(c) a retractable spool coupled to the housing wherein the spool holds a length of headphone cable, and also has a central aperture with leads that engage the headphone cable, wherein the leads rotatably engage the second end of the connector cable.

2. The retractable headphone assembly of claim 1 wherein said second end of the connector cable has a connecting portion having three conducting regions, each of said conducting regions being electrically insulated from one another and electrically coupled to one of three conducting brackets.

3. The retractable headphone assembly of claim 1, further comprising a means for attaching said housing to one or more garments worn by a user.

4. The retractable headphone assembly of claim 1 wherein said retractable spool is coupled to the housing by means of a spool covering which includes an actuator mechanism adapted to engage said spool, whereby the rotation of said spool may be arrested.

5. The retractable headphone assembly of claim 1 wherein said retractable spool includes a fixed portion and a rotatable portion, said rotatable portion adapted to rotate relative to said fixed portion, whereby said rotatable portion holds said length of headphone cable.

6. The retractable headphone assembly of claim 5 wherein a spring is attached to each of said fixed portion and said rotatable portion and wherein said spring provides a retracting force.

7. The retractable headphone assembly of claim 1 wherein a spring is attached to said retractable spool and to said housing, wherein said spring provides a retracting force.

8. The retractable headphone assembly of claim 1, further comprising a means for attaching said housing to a user.

9. The retractable headphone assembly of claim 8 wherein said means for attaching said housing to a user comprises an armband fastened to said housing, wherein said armband is worn around an arm of a user.

10. The retractable headphone assembly of claim 8 wherein said means for attaching said housing to a user comprises a strap having two ends attached to said housing, wherein said strap is worn around a user's neck.

11. The retractable headphone assembly of claim 1 wherein said leads comprise a plurality of conducting brackets adapted for mounting within said central aperture and electrically coupled to said headphone cable, each of said conducting brackets containing a plurality of contact surfaces which engage said second end of the connector cable, whereby said second end of the connector cable and said headphone cable are electrically coupled.

12. The retractable headphone assembly of claim 1 wherein said housing includes a portion defining an aperture, wherein said connector cable passes through said aperture.
